(19) United States
(12) Patent Application Publication
(10) Pub. No.: US 2019/0039939 A1
(43) Pub. Date: Feb. 7, 2019

(54) THERMALLY TEMPERED GLASS SHEETS HAVING SMALL-SCALE INDEX OR BIREFRINGENCE PATTERNS

(71) Applicant: Corning Incorporated, Corning, NY (US)

(72) Inventors: Dana Craig Bookbinder, Corning, NY (US); Jeffrey John Domey, Elmira, NY (US); Michael S Pambianchi, Corning, NY (US); John Christopher Thomas, Elmira, NY (US); Kevin Lee Wasson, Elmira, NY (US)

(21) Appl. No.: 16/073,955

(22) PCT Filed: Jan. 31, 2017
(86) PCT No.: PCT/US17/15828

§ 371 Date: Jul. 30, 2018

Related U.S. Application Data
(60) Provisional application No. 62/289,334, filed on Jan. 31, 2016.
(60) Provisional application No. 62/428,263, filed on Nov. 30, 2016.

(51) Int. Cl. C03B 29/08; C03B 27/016; C03B 27/04; C03B 35/24; C03C 23/00; C03B 27/044

(52) U.S. Cl. CPC C03B 29/08; C03B 27/016; C03B 27/0413; C03C 2204/08; C03C 23/007; C03B 27/044; C03B 35/24

(57) ABSTRACT

A strengthened glass or glass ceramic sheet has a roughness of greater than 0.05 nm Ra and less than 0.08 nm Ra over an area of 10 μm×10 μm and has the property that, excluding areas within three sheet thicknesses of the outer edge surface of the sheet, the slope of a measured value of a thermally affected property of glass over distance along the first major surface of the sheet is higher bordering one or more lower-cooling-rate-effect-exhibiting areas on the first surface of the sheet than elsewhere on the first surface of the sheet, and at least one of said one or more areas has a shortest linear dimension, in a direction parallel to the first major surface, of less than 100000 μm.

This application claims the benefit of priority of U.S. Provisional Application No. 62/289,334, filed on Jan. 31, 2016, and of U.S. Provisional Application No. 62/428,263, filed on Nov. 30, 2016, the content of which is relied upon and incorporated herein by reference in its entirety.

This application is related to and hereby incorporates herein by reference in full the following applications: Provisional Application Ser. No. 62/288,177 filed on Jan. 28, 2016, U.S. Provisional Application Ser. No. 62/288,615 filed on Jan. 29, 2016, U.S. Provisional Application Ser. No. 62/428,142 filed on Nov. 30, 2016, and U.S. Provisional Application Ser. No. 62/428,168, filed on Nov. 30, 2016, U.S. Provisional Application Ser. No. 62/288,851, filed on Jan. 29, 2016, U.S. application Ser. No. 14/814,232, filed on Jul. 30, 2015; U.S. application Ser. No. 14/814,181, filed on Jul. 30, 2015; U.S. application Ser. No. 14/814,274, filed on Jul. 30, 2015; U.S. application Ser. No. 14/814,293, filed on Jul. 30, 2015; U.S. application Ser. No. 14/814,303, filed on Jul. 30, 2015; U.S. application Ser. No. 14/814,363, filed on Jul. 30, 2015; U.S. application Ser. No. 14/814,319, filed on Jul. 30, 2015; U.S. application Ser. No. 14/814,335, filed on Jul. 30, 2015; U.S. Provisional Application No. 62/031,856, filed Jul. 31, 2014; U.S. Provisional Application No. 62/074,838, filed Nov. 4, 2014; U.S. Provisional Application No. 62/031,856, filed Apr. 14, 2015; U.S. application Ser. No. 14/814,232, filed Jul. 30, 2015; U.S. application Ser. No. 14/814,181, filed Jul. 30, 2015; U.S. application Ser. No. 14/814,274, filed Jul. 30, 2015; U.S. application Ser. No. 14/814,293, filed Jul. 30, 2015; U.S. application Ser. No. 14/814,303, filed Jul. 30, 2015; U.S. application Ser. No. 14/814,363, filed Jul. 30, 2015; U.S. application Ser. No. 14/814,319, filed Jul. 30, 2015; U.S. application Ser. No. 14/814,335, filed Jul. 30, 2015; U.S. Provisional Application No. 62/236,296, filed Oct. 2, 2015; U.S. Provisional Application No. 62/288,549, filed Jan. 29, 2016; U.S. Provisional Application No. 62/288,566, filed Jan. 29, 2016; U.S. Provisional Application No. 62/288,615, filed Jan. 29, 2016; U.S. Provisional Application No. 62/288,695, filed on Jan. 29, 2016; U.S. Provisional Application No. 62/288,755, filed on Jan. 29, 2016.

### FIELD

This disclosure relates to improved thermally tempered glass and more specifically to thermally strengthened glass sheets having both higher overall uniformity and smaller-scale index or birefringence patterns than generally producible by standard thermal tempering.

### BACKGROUND

Commonly-assigned U.S. Pat. No. 9,296,638 (the '638 patent) entitled “Thermally Tempered Glass and Method and Apparatuses for Thermal Tempering of Glass” discloses methods and apparatuses for heating and/or thermally tempering glass sheets. The contents of the '638 patent are relied upon and incorporated herein by reference in their entirety for purposes of U.S. law.

### DEFINITIONS

The phrases “glass sheet(s)” and “glass ribbon(s)” are used broadly in the specification and in the claims and include sheet(s) and ribbon(s) that comprise one or more glasses and/or one or more glass-ceramics, as well as laminates or other composites that include one or more glass and/or one or more glass-ceramic components. The phrase “glass sheet(s)” is used to refer to glass sheet(s) and glass ribbon(s) collectively. “Glass” includes glass and materials known as glass ceramics.

### SUMMARY

According to embodiments, a strengthened glass sheet comprises a first major surface, a second major surface opposite the first major surface, an interior region located between the first and second major surfaces, and an outer edge surface extending between and bordering the first and second major surfaces such that the outer edge surface defines the perimeter of the sheet, wherein the sheet comprises a glass and is thermally strengthened; and wherein the first major surface has a roughness in the range of from 0.05 to 0.8 nm Ra over an area of 10 μm×10 μm; and wherein, excluding areas within three sheet thicknesses of the outer edge surface of the sheet, the slope of a measured value of a thermally generated or thermally affected property of glass over distance along the first major surface of the sheet is higher bordering one or more lower-cooling-rate-effect-exhibiting areas on the first surface of the sheet than elsewhere on the first surface of the sheet, and at least one of said one or more areas has a shortest linear dimension, in a direction parallel to the first major surface, of less than 100000 μm, or as little as only or only 3000, 2000, 1000, 500, 400, 300, 200, 150, 100, 70, 50, 40 or even 30 μm.

According to embodiments, the thermally generated or affected property is through-sheet retardation measured in transmission normal to the first major surface according to ASTM F218. The slope of said retardation may be at least 5 nm per mm, 10 nm per mm, 20 nm per mm, 30 nm per mm, or even 40, 50, 60, 80 or 100 nm per mm, all per mm thickness of the sheet.

According to embodiments, the thermally generated or affected property may be optical index of refraction, measured in transmission through the sheet normal to the first major surface. The slope of said index of refraction may be positive in the direction into said one or more areas, and may be as great as at least 0.00001 per mm, or at least 0.0001, 0.001, 0.01, or even 0.1 per mm.

According to embodiments, the thermally generated or affected property may be fictive temperature. For measuring purposes, fictive temperature is determined by temper-stress compensated Raman spectroscopy shift, as disclosed and described in the '638 patent. The slope of said fictive temperature bordering said one or more areas may be negative in the direction into said one or more areas. The slope of said fictive temperature may be at least 5° C. per mm, or 10, 15, 20, 25, 30, 40, 50, 70 or even 100° C. per mm.

According to still further embodiments compatible with all others above, the one or more areas on the first surface of the strengthened glass sheet can be arranged in a pattern corresponding to a pattern of through holes in a heat sink gas bearing surface. They also can be arranged in a pattern corresponding only in part to a pattern of through holes in a heat sink gas bearing surface. They also can be arranged in a pattern not corresponding to a pattern of through holes in a heat sink gas bearing surface.

According to embodiments, potentially useful applications include applications in the pattern of the one or more areas forms a logo or other recognizable symbol, or a machine-readable pattern.

According to embodiments, in areas of the first major surface not forming part of said one or more areas, a normalized standard deviation Sₙ

$${s}_{n} = \frac{s}{\overline{x}}$$

of differential retardance measurement samples taken according to ASTM F218 through the first major surface of the sheet in a series of samples N=10 at locations distributed at intervals of distance d with 0.01 mm≤d≤1000 mm mm along the first major surface and along a center line between borders of the one or more areas and/or between borders of the one or more areas and the outer edge surface of the sheet, but not within 3 times the thickness of the sheet distance to the outer edge surface, is less than or equal to 0.05, or to 0.02, 0.015, 0.01, 0.005, 0.002, or even less than or equal to 0.001. The distance d may be 0.1 mm≤d≤100 mm, 0.1 mm≤d≤100 mm, and 1 mm≤d≤10 mm, the number of samples N may be 10, 100, 500, 1000, 10000.

Apparatus and methods for producing the glass sheets are also disclosed.

The reference characters used are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as exemplified by the description herein. The accompanying drawings are included to provide a further understanding of the invention, and are incorporated in and constitute a part of this specification. It is to be understood that the various features of the invention disclosed in this specification and in the drawings (which are not to scale) can be used individually and in any and all combinations.

### BRIEF DESCRIPTION OF THE DRAWINGS

FIG. 1 is a schematic cross sectional side view drawing of an embodiment of a heat sink or source for heating or cooling a glass sheet.

FIG. 2 is a schematic cross sectional side view drawing of an embodiment of an apparatus for heating and then quenching glass sheets.

FIG. 3 is a schematic cross-sectional plan view drawing of an embodiment of a heat source.

FIG. 4 is a perspective view drawing of a sheet or sheet comprising glass.

FIG. 5 is a schematic cross sectional side view drawing of an embodiment of a heat sink or source.

FIG. 6 is a schematic cross sectional side view drawing of another embodiment of a heat sink or source.

FIG. 7 is a plan view of a heat sink having through holes for supplying gas to a gap.

FIGS. 8-10 are plan views of patterns on strengthened glass sheets producible using the heat sink of FIG. 7 according to various methods disclosed herein.

FIGS. 11-13 are plan views of additional embodiments of heat sink having through holes for supplying gas to a gap.

FIGS. 14 and 15 are plan views of embodiments of porous heat sinks having patterned features thereon.

### DETAILED DESCRIPTION

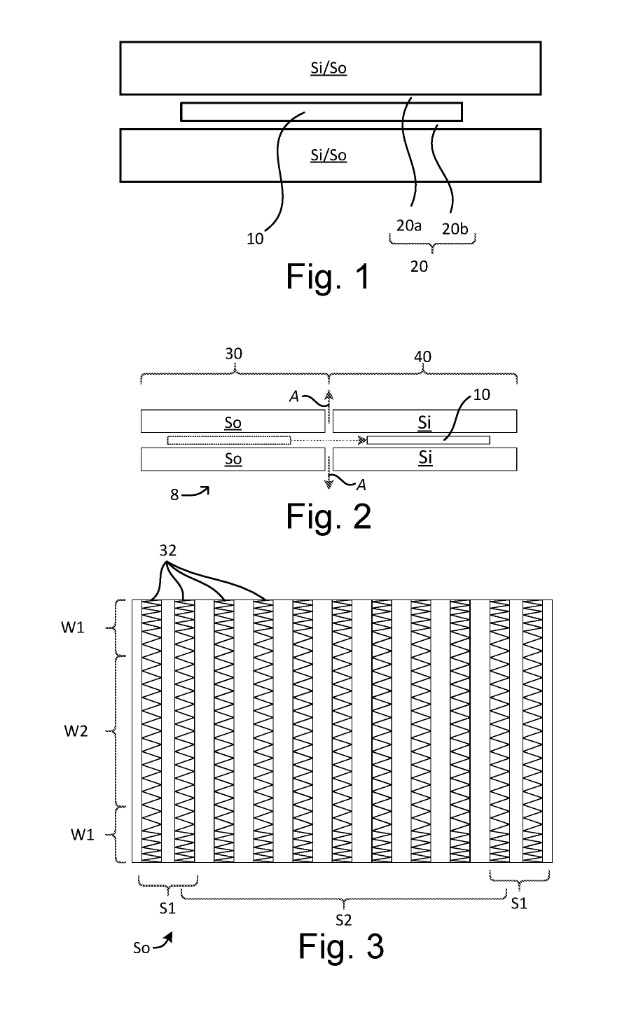

FIG. 1 is a schematic cross sectional side view drawing of an embodiment of an arrangement of a pair of heat sinks or sources Si/So for heating or cooling a glass sheet 10. Thin gaps 20 between the sheet 10 and the heat sinks or sources Si/So contain a gas through which heat is conducted to heat or cool the sheet 10 such that at least 20% of the total heating or cooling is by conduction, desirably 30, 40, 50, 60, and even 70, 80 or 90% or more. The sheet 10 is supported between the two sinks or sources Si/So by any suitable and most preferably non-contact means, including such alternatives as ultrasonic energy, electrostatic forces, but preferably by gas bearings formed in the gaps 20 (comprising first gap 20a and second gap 20b).

The sheet 10 can be stationary or in motion between the sinks or sources Si/So. The sheet 10 can be smaller (in one dimension or both) than the extent of the sinks or sources Si/So or larger (preferably in one dimension only, in which case continuous processing in the larger direction is preferred). The sheet 10 can be multiple sheets heated or cooled together at the same time. The gas in the first and second gaps 20a and 20b can be the same or different, and both or either can be gas mixtures or essentially pure gases. Generally, gases or gas mixtures with relatively higher thermal conductivity are preferred. Use of gas bearings allows robustly maintaining the desired size of the gaps 20a and 20b, which enables relatively homogeneous heat transfer rates over all areas of the gaps 20, in comparison to cooling or heating by direct contact with liquids or with solids, and in comparison to cooling by forced air convection.

As represented in the diagrammatic cross section of FIG. 2, a thermal tempering or strengthening apparatus 8 generally includes both a heating zone 30 and a cooling zone 40, and both can be in the form of a pair of heat sources So or a pair of heat sinks Si, separated from the sheet by thin gas gaps 20 as in FIG. 1. As an alternative, the heating zone may be in the form of a conventional furnace or oven rather than the thin-gap arrangement of heat sources So shown here. In general terms, heating zone 30 heats the glass sheet(s) to a temperature sufficient for thermal strengthening, and the cooling zone 40 lowers the temperature of the sheet(s) by removing heat through the surfaces of the sheet(s) at a rate sufficient and for a sufficient time to achieve a desired level of thermal strengthening when the sheet(s) are (later) finally at ambient temperatures. A sheet 10 is heated to a sufficient temperature for generating temper effects (generally between the glass transition point and the softening point of the glass), and is cooled in the cooling zone. Transport may be by any suitable means.

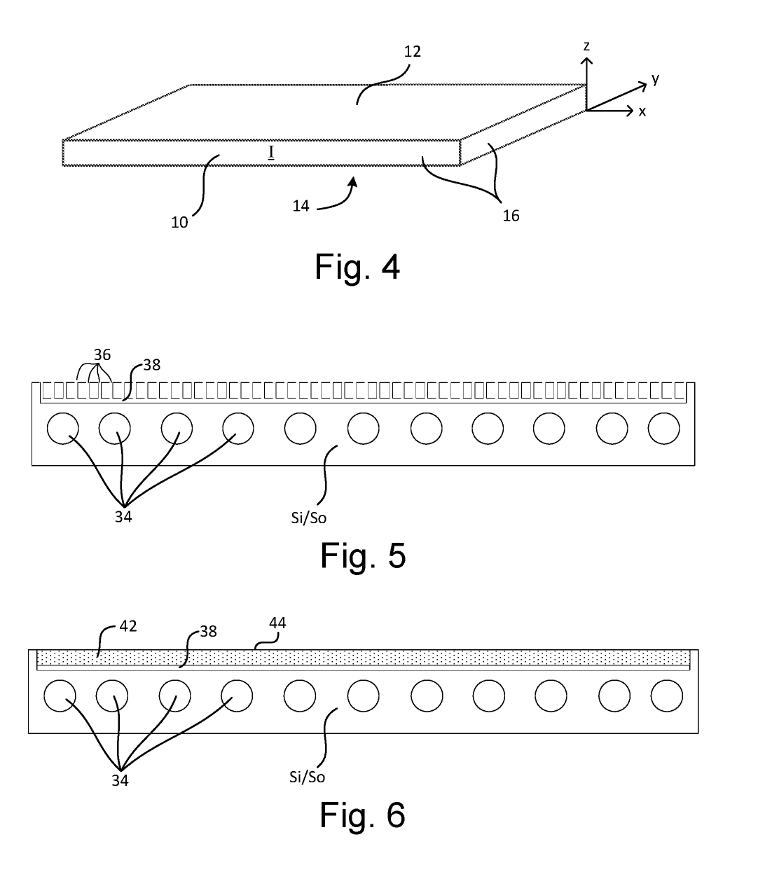

FIG. 4 shows a perspective view of the sheet 10 comprising glass, which includes a first major surface 12, a second major surface 14 opposite the first (the obscured underside in the view shown in the figure), an interior region I located between the first and second major surfaces, and an outer edge surface 16 extending between and surrounding the first and second major surfaces such that the outer edge surface defines the perimeter of the sheet. x-y-z coordinates are shown for ease of reference, with z in the thickness direction.

Gas bearings, as alternative embodiments, may take either of the forms shown in FIGS. 5 and 6. FIG. 5 is a schematic cross sectional side view drawing of one embodiment of a heat sink or source Si/So, and FIG. 6 is a schematic cross sectional side view drawing of another embodiment of a heat sink or source Si/So. In both of these embodiments, the circular structures are thermal control structures 34, such as cartridge heaters if the embodiment is a heat source So, or such as coolant passages if the embodiment is a heat sink Si. The embodiment of FIG. 5 employs discrete holes 36 through which gas can be fed from a plenum 38. The embodiment of FIG. 6 includes a porous structure 42 through which gas can likewise be fed from a plenum 38, with the effect that the gas is emitted essentially from every portion of the surface 44 of the porous structure 42.

Because of the non-contact treatment and handling possible in the thermal strengthening apparatus of FIG. 2, by using gas bearings such as in FIGS. 5 and 6 or by other suitable non-contact means, the first major surface 12 of the sheet 10 can have very low roughness, achieved by preserving the as-floated quality of the “air side” of float glass, or the as-drawn quality of either side of fusion-drawn glass. The Ra roughness, measured over an area on the first major surface of 10 μm×10 μm according to the standard of ISO 19606, can be in the range of from 0.05 or 0.1 nm to 20, 4, 0.8, 0.7, 0.6, 0.5, 0.4, 0.3 or even as low as to 0.2 nm Ra. The self-restoring or self-centering effects of opposing gas bearings can also assist in keeping thin glass sheets flat, even very thin sheets. Thin sheets with thicknesses within in the range of from 0.1, 0.2 or 0.5 mm to 3, 2.8, 2.6, 2.4, 2.2, 2.0, 1.8, 1.6, 1.4, 1.2, 1.1, 1, 0.9, 0.8, 0.7, 0.6 mm can be processed, as well as thicker sheets.

Achieving uniformity of cooling effects in the cooling zone 40 over the area of the sheet 10 requires maintaining the desired size of the gaps 20. It has also been found that maintaining the homogeneity of the gas in the gaps 20a, 20b within the cooling zone is important. If different gases are used in the heat source So gaps and the heat sink Si gaps, gas can be drawn away by a suitable suction or vacuum means at a position between the sources So and the sinks Si, as indicated by the arrows A in FIG. 2, so that the differing gases do not mix within the heat sinks Si of the cooling zone (or within the heat sources So). Alternatively and optionally, a transition zone such as is disclosed in the '638 patent, positioned between the heating and cooling zone, can include a feed of the same gas as in the cooling zone and can physically isolate the heating zone gas from the cooling zone gas in the case that they are different. Interestingly, and in contrast to forced convective gas tempering, when the gases are the same and (as in the present disclosure) conduction is the dominant heat transfer mode, any hot gas traveling with the sheet 10 from hot zone 30 to cold zone 40 is not a very significant factor in the process, since the thermal mass of the gas is negligible relative to the effects of conduction.

For good homogeneity of heat transfer rates during heating and resulting homogeneous temperature profiles and final properties of sheet 10, it is also desirable to provide a heat source So providing for a non-uniform distribution of heating energy. FIG. 3 shows diagrammatic cross sectional plan view of a heat source So such as those of FIGS. 1 and 2, having such a non-uniform distribution of heating energy in the form of cartridge heaters 32 distributed within the heat source So. A first spacing S1 of the cartridge heaters near the left and right edges of the heat source So in the figure is closer than a second spacing S2 of the cartridge heaters in the more central region of the heat source So. This has the effect, desired in most circumstances, of balancing thermal losses to the ambient environment at the left and right edges of the heat source So. Similarly, the windings within the cartridge heaters 32 can have a first average winding density W1 near the edges (top and bottom in the figure) of the heat source So greater than a second average winding density W2 in the more central region of the heat source So.

With good control of the thermal profile of the sheet just before cooling, such as may be achieved by the heat source So of FIG. 3 or by other suitable means, and with steps taken to prevent unwanted gas mixing in the heat sink Si, as described in connection with FIG. 2 or by other suitable means, thermally strengthened sheets comprising glass can be produced having very good quality, especially relative to the achieved strengthening as a function of glass thickness and glass properties. In particular, the improved properties can include improved homogeneity of membrane stresses.

For example, a sheet processed according to this disclosure in combination with the disclosure of the '638 patent can achieve a desirable low deviation of membrane stress, such that, in areas of the first major surface not forming part of said one or more areas, a normalized standard deviation Sₙ

$${s}_{n} = \frac{s}{\overline{x}}$$

of differential retardance measurement samples taken according to ASTM F218 through the first major surface of the sheet in a series of samples N=10 at locations distributed at intervals of distance d with 0.01 mm≤d≤1000 mm mm along the first major surface and along a center line between borders of the one or more areas and/or between borders of the one or more areas and the outer edge surface of the sheet, but not within 3 times the thickness of the sheet distance to the outer edge surface, is less than or equal to 0.05, or to 0.02, 0.015, 0.01, 0.005, 0.002, or even less than or equal to 0.001. The distance d may be 0.1 mm≤d≤100 mm, 0.1 mm≤d≤100 mm, and 1 mm≤d≤10 mm, the number of samples N may be 10, 100, 500, 1000, 10000.

By employing the gas bearing embodiment of FIG. 5, which uses discrete holes 36 to feed gas to the gaps 20 of FIG. 1, as a heat sink Si for quenching a glass sheet 10, thermally strengthened glass sheets having small-scale index or birefringence patterns of various types can be produced. Depending on the type of patterned to be produced, different conveyance methods are used as follows: If a pattern directly corresponding to discrete holes of 36 is to be produced, then the sheet is conveyed or otherwise brought very quickly into position in the cooling zone 40 if FIG. 2, then stopped and left or held stationary at least to the point of cooling to a temperature at or below a glass transition temperature of the glass, as measured on a first or second major surface 12, 14 of the sheet 10, desirably to the point of the whole sheet reaching a temperature below the glass transition temperature of the glass. If, on the other hand, a pattern of lines is to be produced, the sheet 10 is conveyed or otherwise caused to move within the cooling zone 40, either continuously in one direction or in oscillations back and forth, of sufficient length to blur together the effects of adjacent ones of holes 36. Shorter oscillations can produce a pattern reflecting elongated holes or “short lines.”

A plane view of an embodiment of a sink Si is shown in FIG. 7 having discrete holes 36 arranged in a regular array pattern. (Figures are for understanding only, and are not to scale.)

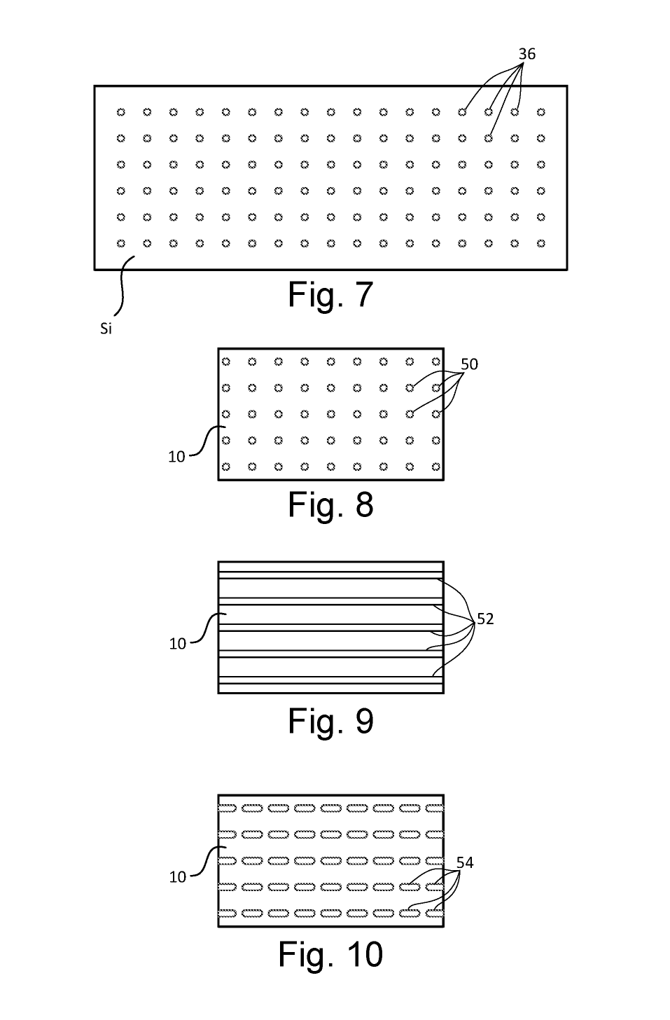

FIG. 8 shows a plan view of a sheet 10 of glass processed using the heat sink Si of FIG. 7, by the method of bringing the sheet 10 quickly into the cooling zone 40, then keeping the sheet 10 stationary during cooling. An image of the pattern of the discrete holes 36 is reproduced in the sheet 10, resulting in one or more lower-cooling-rate-effect-exhibiting areas in the form of circular areas 50.

FIG. 9 shows a plan view of a sheet 10 of glass processed using the heat sink Si of FIG. 7, by the method of moving the sheet 10 continuously in one direction in the cooling zone 40 or moving the sheet 10 continuously and quickly back and forth in the cooling zone 40, with the range of motion greater than the distance between the holes 36 of the heat sink. A “smeared” image of the pattern of the discrete holes 36 is reproduced in the sheet 10, resulting in one or more lower-cooling-rate-effect-exhibiting areas in the form of lines or linear areas 52 as represented in FIG. 9.

FIG. 10 shows a plan view of a sheet 10 of glass processed using the heat sink Si of FIG. 7, by the method of moving the sheet 10 continuously and quickly back and forth in the cooling zone 40, with the range of motion less than the distance between the holes 36 of the heat sink. A “smeared” image of the pattern of the discrete holes 36 is reproduced in the sheet 10, resulting in one or more lower-cooling-rate-effect-exhibiting areas in the form of the short linear areas 54 (or “elongated circular areas” 54) as represented in FIG. 10.

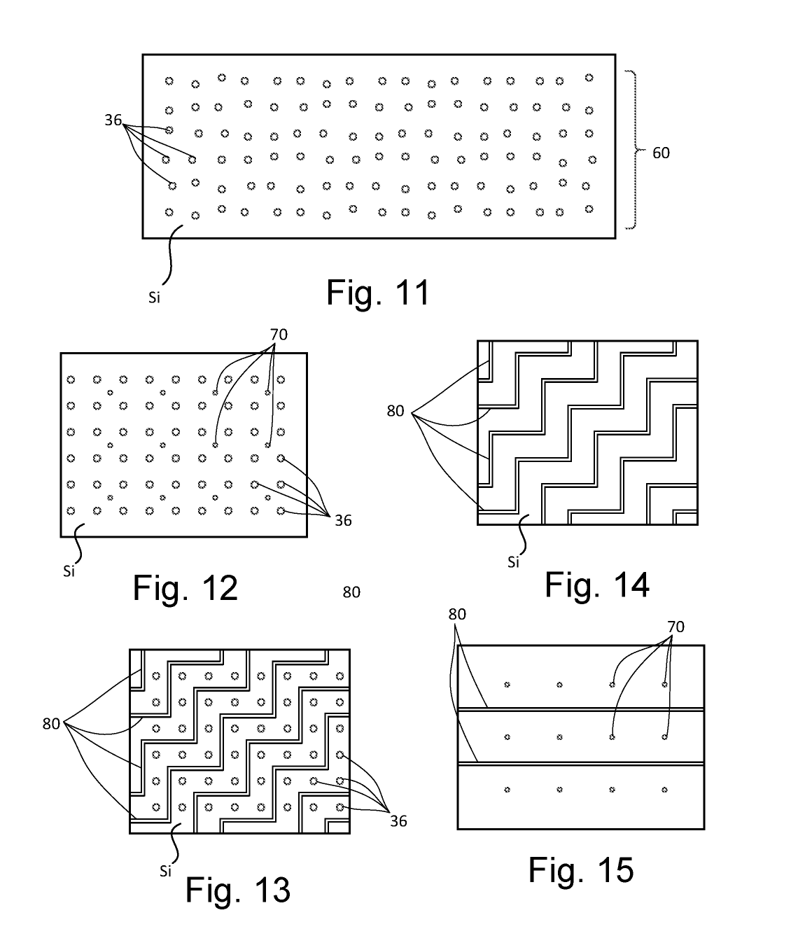

FIGS. 11-13 show three additional embodiments of heat sinks Si having discrete holes 36 for supplying gas to the gaps 20 of FIG. 1.

The embodiment of FIG. 11 has a random or quasi-random pattern 60. Such a pattern may be used to produce sheets that are recognizable when needed, (such as by a machine reader or other image recognition technology, or by careful inspection) but that may be not easily distinguished by normal viewing.

FIG. 12 shows an embodiment in which small holes or depressions 70 are included in the surface of the heat sink Si for decorative effect on the glass sheet. The small holes need not conduct gas, but in the presence of a hole or sufficiently deep depression, because conduction dominates the heat transfer, heat transfer during cooling is significantly reduced at the fine point represented simply by the small hole or depression 70, producing, on a stationary-cooled glass sheet (not shown), corresponding lower-cooling-rate-effect-exhibiting areas mirroring the depressions 70.

FIG. 13 shows a heat sink Si having small lines or trenches 80 machined or engraved or otherwise formed in the surface thereof. These are desirably shallow and narrow enough not to have any large effect on the heat sink's ability to function as a gas bearing. Lines or trenches 80, together with quick transport followed by stationary cooling as the method of operation, allow complicated lower-cooling-rate-effect-exhibiting areas in the form of multi-directional lines and similar decorative patterns to be produced on the glass sheet.

FIG. 14 is a plan view of an embodiment of a heat sink Si of porous type, such as in FIG. 6 above (with pores not visible in FIG. 14). The porous heat sink Si of FIG. 14 includes lines or trenches 80. FIG. 15 is a plan view of another embodiment of a heat sink Si of porous type, including both lines or trenches 80 and small holes or depressions 70. Heat sinks such as these two embodiments allow for the production of glass sheets having patterns of lower-cooling-rate-effect-exhibiting areas not corresponding to any particular necessary pattern of through holes in a heat sink gas bearing surface.

The patterns are subtle because they are produced by non-contact thermal effects, namely, by one or more lower-cooling-rate-effect-exhibiting areas corresponding the discrete holes, or to the holes or depressions, or to the lines or trenches or other patterns, and so are detectable through measurements that are able to detect the differing local thermal histories on the sheet. These include birefringence measurements such as retardance through the sheet or observation by the human eye in polarized light; measurements of index of refraction such as through-sheet inteferometry (where oil-on-flats techniques may be used to avoid the need to polish the specimen under test); measurement of fictive temperature variations, and the like.

Although the patterns are typically subtle to the unaided human eye, they are unusual in thermally strengthened glass sheets in that the slope of a given measured property over distance across the first major surface of the sheet is unusually high (meaning unusually steep, meaning unusually high in absolute value) relative to glass sheets strengthened by other methods, at the locations and in the directions crossing the borders of the one or more areas which make up the patterns.

The patterns are also unusual in thermally strengthened glass sheets in that the one or more areas which make up the patterns can be very thin, or more technically expressed, the shortest linear dimension of at least one of the one or more areas, in a direction parallel to the first major surface of the sheet, may be very small relative to patterns produced by other thermal strengthening methods, though it may be also be large if desired.

The product that results may be characterized as a strengthened glass sheet comprising a first major surface, a second major surface opposite the first major surface, an interior region located between the first and second major surfaces, an outer edge surface extending between and surrounding the first and second major surfaces such that the outer edge surface defines the perimeter of the sheet, wherein the first major surface has a roughness of greater than 0.05 nm and less than 0.8 nm Ra over an area of 10 μm×10 μm; and wherein, excluding areas within three sheet thicknesses of the outer edge surface of the sheet (to avoid edge effects), the slope of a measured value of a thermally generated or thermally or affected property of glass over distance along the first major surface of the sheet is higher bordering one or more areas on the first surface of the sheet than elsewhere on the first surface of the sheet, and said areas have a shortest linear dimension, in a direction parallel to the first major surface, of less than 100000 μm, or only 3000, 2000, 1000, 500, 400, 300, 200, 150, 100, 70, 50, 40 or even 30 μm.

According to embodiments, the thermally generated or affected property is through-sheet retardation measured in transmission normal to the first major surface according to ASTM F218. The slope of said retardation may be at least 5 nm per mm, 10 nm per mm, 20 nm per mm, 30 nm per mm, or even 40, 50, 60, 80 or 100 nm per mm, all per mm thickness of the sheet.

According to embodiments, the thermally generated or affected property may be optical index of refraction, measured in transmission through the sheet normal to the first major surface. The slope of said index of refraction may be positive in the direction into said one or more areas, and may be as great as at least 0.00001 per mm, or at least 0.0001, 0.001, 0.01, or even 0.1 per mm.

According to embodiments, the thermally generated or affected property may be fictive temperature, measured at the first surface of the sheet according to the method disclosed in U.S. Pat. No. 9,296,638. The slope of said fictive temperature bordering said one or more areas may be negative in the direction into said one or more areas. The slope of said fictive temperature may be at least 5° C. per mm, or 10, 15, 20, 25, 30, 40, 50, 70 or even 100° C. per mm.

As will be understood from the foregoing, according to still further embodiments compatible with all others above, the one or more areas on the first surface of the strengthened glass sheet can be arranged in a pattern corresponding to a pattern of through holes in a heat sink gas bearing surface. They also can be arranged in a pattern corresponding only in part to a pattern of through holes in a heat sink gas bearing surface. They also can be arranged in a pattern not corresponding to a pattern of through holes in a heat sink gas bearing surface.

Potentially useful applications include applications in the pattern of the one or more areas forms a logo or other recognizable symbol, or a machine-readable pattern.

In areas of the first major surface not forming part of said one or more areas, the good uniformity produced by the apparatuses and methods of the present disclosure can result in areas of the first major surface centered between borders of said one or more areas (and also not within three thicknesses of the outer edge surface) having the a desirable low deviation of membrane stress mentioned above, such that a normalized standard deviation Sₙ

$${s}_{n} = \frac{s}{\overline{x}}$$

of a sample of either membrane stress or differential retardance measurement samples, taken according to ASTM F218 through the first major surface 12 of the sheet 10 in a series of samples N=100 at locations distributed along the first major surface and centered between borders of the one or more areas, is low (when edge effects of measuring too close—i.e., within 3 times the thickness of the sheet to the outer edge surface 16 are not included)—as low as 0.02, 0.015, 0.01, 0.005, 0.002, 0.001 or even lower.

A variety of modifications that do not depart from the scope and spirit of the invention will be evident to persons having ordinary skill in the art from the foregoing disclosure.

1. A strengthened glass sheet comprising:
a first major surface;
a second major surface opposite the first major surface;
an interior region located between the first and second major surfaces;
an outer edge surface extending between and bordering the first and second major surfaces such that the outer edge surface defines the perimeter of the sheet,
wherein the sheet comprises a glass and is thermally strengthened; and
wherein the first major surface has a roughness in the range of from 0.05 to 0.8 nm Ra over an area of 10 μm×10 μm; and
wherein, excluding areas within three sheet thicknesses of the outer edge surface of the sheet, the slope of a measured value of a thermally generated or thermally affected property of glass over distance along the first major surface of the sheet is higher bordering one or more lower-cooling-rate-effect-exhibiting areas on the first surface of the sheet than elsewhere on the first surface of the sheet, and at least one of said one or more areas has a shortest linear dimension, in a direction parallel to the first major surface, of less than 100000 μm.

2. The strengthened glass sheet according to claim 1 wherein the thermally generated property is through-sheet retardation.

3. The strengthened glass sheet according to claim 2 wherein the slope bordering said one or more areas on the first surface of the sheet is at least 5 nm per mm, per mm thickness of the sheet.

4. The strengthened glass sheet according to claim 2 wherein the slope bordering said one or more areas on the first surface of the sheet is at least 10 nm per mm, per mm thickness of the sheet.

5. The strengthened glass sheet according to claim 2 wherein the slope bordering said one or more areas on the first surface of the sheet is at least 20 nm per mm, per mm thickness of the sheet.

6. The strengthened glass sheet according to claim 1 wherein the thermally generated property is optical index of refraction, measured in transmission through the sheet normal to the first major surface.

7. The strengthened glass sheet according to claim 6 wherein the slope bordering said one or more areas on the first surface of the sheet is positive in the direction into said one or more areas.

8. The strengthened glass sheet according to claim 6 wherein the slope bordering said one or more areas on the first surface of the sheet is at least 0.00001 per mm.

9. The strengthened glass sheet according to claim 6 wherein the slope bordering said one or more areas on the first surface of the sheet is at least 0.0001 per mm.

10. The strengthened glass sheet according to claim 6 wherein the slope bordering said one or more areas on the first surface of the sheet is at least 0.001 per mm.

11. The strengthened glass sheet according to claim 1 wherein the thermally generated property is fictive temperature the first surface of the sheet.

12. The strengthened glass sheet according to claim 11 wherein the slope bordering said one or more areas is negative in the direction into said one or more areas.

13. The strengthened glass sheet according to claim 11 herein the slope bordering said one or more areas on the first surface of the sheet is at least 10° C. per mm.

14. The strengthened glass sheet according to claim 11 wherein the slope bordering said one or more areas on the first surface of the sheet is at least 20° C. per mm.

15. The strengthened glass sheet according to claim 1 wherein said at least one area has a shortest linear dimension, in a direction parallel to the first major surface, of less than 3000 μm.

16. The strengthened glass sheet according to claim 15 wherein said at least one area has a shortest linear dimension, in a direction parallel to the first major surface, of less than 1000 μm.

17. The strengthened glass sheet according to claim 15 wherein said at least one area has a shortest linear dimension, in a direction parallel to the first major surface, of less than 300 μm.

18. The strengthened glass sheet according to claim 15 wherein said at least one area has a shortest linear dimension, in a direction parallel to the first major surface, of less than 50 μm.

19. The strengthened glass sheet according to claim 15 wherein the one or more areas form a pattern corresponding to a pattern of through holes in a heat sink gas bearing surface.

20. The strengthened glass sheet according to claim 19 wherein the one or more areas form a pattern corresponding only in part to a pattern of through holes in a heat sink gas bearing surface.

21. The strengthened glass sheet according to claim 19 wherein the one or more areas form a pattern not corresponding to a pattern of through holes in a heat sink gas bearing surface.

22. The strengthened glass sheet according to claim 19 wherein said pattern forms a logo or other recognizable symbol.

23. The strengthened glass sheet according to claim 19 wherein said pattern is a machine-readable pattern.

24. The strengthened glass sheet according to claim 19 wherein a normalized standard deviation Sₙ
$${s}_{n} = \frac{s}{\overline{x}}$$
of differential retardance measurement samples taken according to ASTM F218 through the first major surface of the sheet in a series of samples N=10 at locations distributed at intervals of distance d with 0.1 mm≤d≤100 mm mm along the first major surface and along a center line between borders of the one or more areas and/or between borders of the one or more areas and the outer edge surface of the sheet, but not within 3 times the thickness of the sheet distance to the outer edge surface, is less than or equal to 0.02.
